(19) United States
(12) Patent Application Publication
(10) Pub. No.: US 2012/0235868 A1
(43) Pub. Date: Sep. 20, 2012

(54) ANTENNA STRUCTURE AND PORTABLE COMMUNICATION TERMINAL

(76) Inventors: Kazunori OSHIRO, Miyagi-ken (JP); Yuichi SHIMIZU, Miyagi-ken (JP); Yasuhiro IKARASHI, Miyagi-ken (JP); Shuichi MISHINA, Miyagi-ken (JP)

(21) Appl. No.: 13/417,866

(22) Filed: Mar. 12, 2012

(30) Foreign Application Priority Data
Mar. 15, 2011 (JP) 2011-056326

(51) Int. Cl. H01Q 1/24

(52) U.S. Cl. 343/702

(57) ABSTRACT

An antenna structure includes an external antenna disposed on a cover detachable from an opening of a housing portion of a casing; an internal antenna disposed on a storage unit and configured to transmit internal information and receive external information and is disposed in the housing portion; and a relay antenna having a first coupling part electromagnetically coupled with the external antenna and a second coupling part electromagnetically coupled with an internal antenna under the condition in which the cover is attached to the opening of the casing.

### CLAIM OF PRIORITY

This application claims benefit of Japanese Patent Application No. 2011-056326 filed on Mar. 15, 2011, which is hereby incorporated in its entirety by reference.

### BACKGROUND

1. Field of the Disclosure

The present disclosure relates to an antenna structure for a communication unit that carries out close-range wireless communication and relates to, for example, an antenna structure for a close-range wireless communication unit installed in a portable communication terminal and a portable communication terminal.

2. Description of the Related Art

In recent years, many portable communication terminals having a close-range wireless communication function, such as near field communication (NFC), have been available. The portable communication terminal having an NFC function has a subscriber identity module (SIM) card installed therein, for example, the bottom surface of a housing portion accommodating a battery; the NFC application function is embedded in the SIM card. To achieve wireless communication with external communication devices, a flexible antenna, such as that described in Japanese Unexamined Patent Application Publication No. 2002-109497, is connected to the SIM card.

Herein, a film antenna is connected to a SIM card in the above-described portable communication terminal to achieve close-range wireless communication. Wirings between the film antenna disposed on an inner surface of a battery cover and the SIM card installed in a housing part of the terminal are routed such that the wirings can save a space for the battery. However, since a film antenna disposed on the battery cover and the wirings disposed at the side of the SIM card are formed in a single piece, the wirings could break due to bending caused by attachment or removal of the battery cover or replacement of the battery.

### SUMMARY

An antenna structure includes an external antenna disposed on a cover detachable from an opening of a housing portion of a casing; an internal antenna disposed on a storage unit and configured to transmit internal information and receive external information and is disposed in the housing portion; and a relay antenna having a first coupling part electromagnetically coupled with the external antenna and a second coupling part electromagnetically coupled with an internal antenna under the condition in which the cover is attached to the opening of the casing.

According to this configuration, since the internal antenna of the storage unit, the relay antenna, and the external antenna on the cover are physically separated but electromagnetically coupled, the antenna wirings can be prevented from breaking due to opening and closing of the cover.

A portable communication terminal includes: a casing having a housing portion with an opening; a cover detachable from the opening of the housing portion; an external antenna disposed on the cover; a storage unit disposed in the housing portion of the casing; an internal antenna disposed on the storage unit and configured to transmit internal information and receive external information; and a relay antenna having a first coupling part electromagnetically coupled with the external antenna and a second coupling part electromagnetically coupled with the internal antenna under the condition in which the cover is attached to the opening of the casing.

### BRIEF DESCRIPTION OF THE DRAWINGS

FIGS. 1A and 1B are overall perspective views of a communication device according to a first embodiment;

FIG. 2 is an enlarged schematic sectional view of a housing portion for a battery in the communication device according to the first embodiment;

FIG. 3 is a schematic plan view of a SIM card according to the first embodiment;

FIG. 4 is a schematic plan view of a film antenna serving as a relay antenna according to the first embodiment;

FIG. 5 is a schematic plan view of a film antenna serving as an external antenna according to the first embodiment; and

FIGS. 6A and 6B are schematic views of an antenna serving as a relay antenna according to a second embodiment.

### DESCRIPTION OF THE EXEMPLARY EMBODIMENTS

Embodiments of the present invention will be described below with reference to the accompanying drawings.

### First Embodiment

An example in which an antenna structure according to this embodiment is applied to a communication unit of a portable communication terminal, such as a mobile phone, will be described.

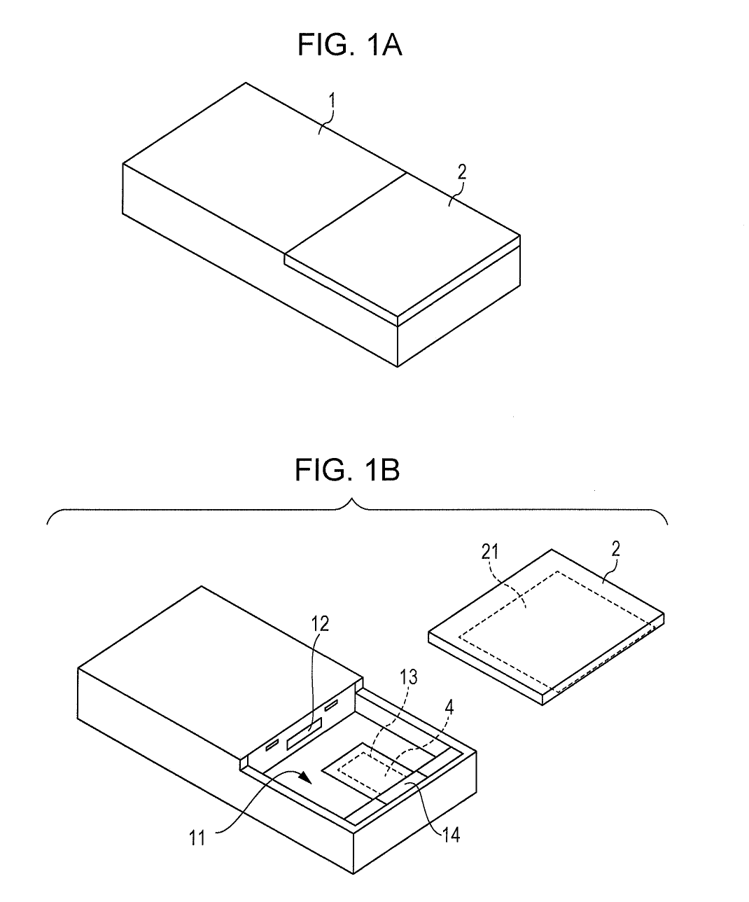

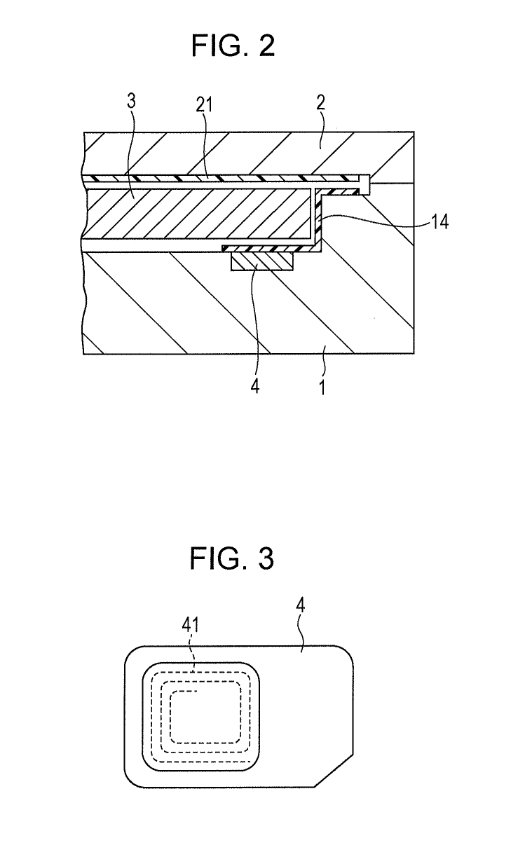

FIGS. 1A and 1B are overall perspective back views of the portable communication terminal in which the antenna structure according to this embodiment is applied; FIG. 1A illustrates a housing portion for a battery in a closed state, and FIG. 1B illustrates the housing portion in an open state. FIG. 2 is a schematic sectional view of the housing portion and the vicinity in the portable communication terminal according to the present invention.

The portable communication terminal, which is illustrated in FIG. 1A, includes a casing 1, which constitutes the rectangular external shape of the portable communication terminal, and a cover 2, which is detachable from a predetermined area on the back of the casing 1 corresponding to a housing portion for a battery. The portable communication terminal is, for example, a mobile phone but instead may be any other portable device. A display unit and an operating unit (not shown) are disposed on the front side of the casing 1.

As illustrated in FIGS. 1B and 2, the cover 2 is substantially shaped as a thin plate, and an external antenna 21, which carries out close-range wireless communication with external communication devices, is disposed on the cover 2 on the side opposing the casing 1. One of the ends (first coupling part) of the external antenna 21 is electromagnetically coupled with a relay antenna 14, which is described below, by electromagnetic induction. The external antenna 21 is constituted of a conductive pattern (film antenna) provided, for example, on a film made of a flexible material.

The casing 1 has a housing portion 11, which is an internal space provided for accommodating a battery 3 (not illustrated in FIG. 1), in the area covered by the cover 2. The housing portion 11 defines a space in which the rectangular battery 3 having a predetermined thickness can be fitted. A sidewall of the housing portion 11 has a connector 12, which is connected to a connecting terminal (not shown) of the battery 3. A SIM card 4, which is a storage unit, is loaded into an installation slot 13 provided on the bottom surface of the housing portion 11.

The SIM card 4 is an IC card holding a unique identification number that specifies, for example, a telephone number of a mobile phone and has an application function for close-range wireless communication, such as NFC. FIG. 3 is an overall schematic plan view of the SIM card 4. As illustrated in FIG. 3, the SIM card 4 includes an internal antenna 41, which can be electromagnetically coupled with the relay antenna 14. The internal antenna 41 is constituted of a conductive pattern provided on the upper surface of the IC card. A protective layer may be applied on the conductive pattern, which constitutes the internal antenna 41.

The relay antenna 14 is electromagnetically coupled with the internal antenna 41 of the SIM card 4 (second coupling part). Thus, at least part (card side) of the relay antenna 14 extends to the bottom surface of the housing portion 11 to reach close to the internal antenna 41. In FIG. 3, the part of the relay antenna 14 extending to the bottom surface of the housing portion 11 covers the inner antenna 41 of the SIM card 4. This part (card side) of the relay antenna 14 may constitute a loop part.

When the cover 2 is closed, the relay antenna 14 is electromagnetically coupled with the external antenna 21 of the cover 2. Hence, another part (cover side) of the relay antenna 14 extends to a position opposing the inner surface of the cover 2 to reach close to the external antenna 21.

The relay antenna 14 is bent and disposed along the wall of the housing portion 11 to save the space for the battery 3 to be fitted in the housing portion 11. The card side of the relay antenna 14 is fixed to the casing 1 from the part close to the external antenna 21 along the wall of the housing portion 11, and a part of the relay antenna 14 on the bottom surface of the housing portion 11 is not fixed on the card side. In this way, it is possible to load and unload the SIM card 4 by lifting the unfixed end of the relay antenna 14.

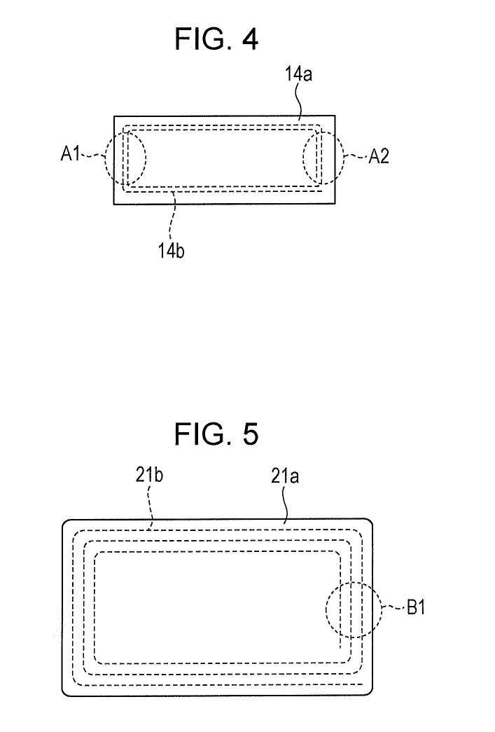

The relay antenna 14 is constituted of, for example, a film antenna. FIG. 4 is a schematic plan view of the film antenna serving as the relay antenna 14. As illustrated in FIG. 4, the film antenna constituting the relay antenna 14 includes a film 14a made of a flexible material and a conductive pattern 14b provided on the film 14a by, for example, a printing process. An end part A1 of the film antenna (relay antenna 14) can be electromagnetically coupled with the inner antenna 41 of the SIM card 4. Another end part A2 can be electrically coupled with the external antenna 21. The film antenna having the flexible film 14a as a base material can be easily deformed and can be bent along the wall of the housing portion 11 when disposed therein.

FIG. 5 is a schematic plan view of the film antenna serving as the external antenna 21 on the cover 2. As illustrated in FIG. 5, the film antenna (external antenna 21) includes a film 21a, which is made of a flexible material, and a conductive pattern 21b provided on the film 21a by, for example, a printing process. An end part B1 of the film antenna (external antenna 21) can be electromagnetically coupled with the relay antenna 14. The film antenna can wirelessly communicate with external communication devices. The shape of the film antenna can be changed in accordance with the shape of the cover 2.

In a portable communication terminal having the above-described configuration, an induced magnetic field is generated near the inner antenna 41 of the SIM card 4 when a signal is transmitted from the inner antenna 41, and an induced electromotive force is generated on a card-side opposing part (second coupling part) of the relay antenna 14, which is electrically coupled with the internal antenna 41. As a result, an electric current (alternating current) flows through the relay antenna 14. A cover-side opposing part (first coupling part) of the relay antenna 14 is electromagnetically coupled with the external antenna 21 on the cover 2, and an induced electromotive force is generated in the external antenna 21 due to the induced magnetic field generated by the current flowing through the relay antenna 14. As a result, an electric current flows through the external antenna 21. In this way, since a current flows through the external antenna 21 as a result of the generated electromotive force corresponding to a signal transmitted from the internal antenna 41 of the SIM card 4, the SIM card 4 can transmit a signal to external communication devices. Similarly, when the SIM card 4 receives a signal, an electromotive force corresponding to the signal received by the external antenna 21 on the cover 2 is generated on the cover-side opposing part (first coupling part) of the relay antenna 14, and an electric current flows as a result of the electromotive force generated in the internal antenna 41 of the SIM card 4, which is electromagnetically coupled with the card-side opposing part (second coupling part) of the relay antenna 14; thus, the SIM card 4 can receive signals from external communication devices. The frequency band of the signals is, for example, 13.56 MHz.

As described above, the portable communication terminal according to this embodiment includes the internal antenna 41 embedded in the SIM card 4, the relay antenna 14, and the external antenna 21 disposed on the cover 2, and the internal antenna 41 and relay antenna 14, and the relay antenna 14 and external antenna 21 are electromagnetically coupled; therefore, antenna wirings do not break due to attachment or removal of the cover 2. In this way, a portable communication terminal with high durability can be acquired.

The since the portable communication terminal of this embodiment includes the relay antenna 14 disposed around the battery 3, and the internal antenna 41 and the external antenna 21 are coupled via the relay antenna 14, communication with external communication devices is possible even with the battery 3, which blocks an electromagnetic field, disposed in the housing portion 11.

The electric coupling between the internal antenna 41 and relay antenna 14 and the electric coupling between the relay antenna 14 and external antenna 21 do not have to be electromagnetic coupling. However, if the antennas are connected via a connection terminal, degradation of the connection terminal may cause unsatisfactory connection. Thus, electromagnetic coupling is desirable as the coupling between the internal antenna 41 and relay antenna 14 and the coupling between the relay antenna 14 and external antenna 21.

This embodiment can be appropriately combined with another embodiment.

### Second Embodiment

An antenna structure according to this embodiment is constituted of a conductive wire bent into a three-dimensional form that can be fit in the housing portion 11. In the following, differences from the first embodiment will be mainly described and similarities will not be repeated. For components that are the same as those in the above-described first embodiment will be represented by the same reference numerals.

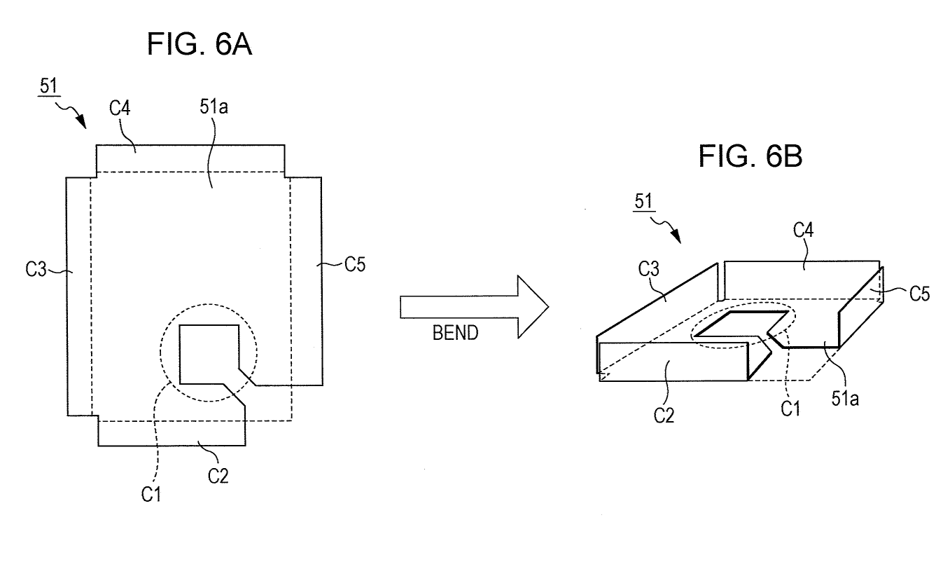

FIGS. 6A and 6B are schematic views of a relay antenna 51, which constitutes a relay antenna in the antenna structure according to this embodiment. FIG. 6A is a plan view of the relay antenna 51. FIG. 6B is a perspective view of the relay antenna 51 shaped for attachment to the casing 1.

A flat conductive wire 51a is bent as illustrated in FIG. 6A. The flat conductive wire 51a that is bent three-dimensionally has a loop part C1, which is electromagnetically coupled with the antenna 41 of the SIM card 4, and four sides C2 to C5, which are disposed at the opening edge parts of the housing portion 11.

As illustrated in FIG. 6B, the flat conductive wire 51a, which is illustrated in FIG. 6A, is bent along the walls of the battery storage 11 to form a parallelepiped that can be fit in the internal space of the housing portion 11. The edges of the four sides C2 to C5 constitute legs having a length corresponding to the depth of the housing portion 11.

As illustrated in FIG. 6B, when the conductive wire 51a bent three-dimensionally is fit in the housing portion 11, the loop part C1 is positioned near the slot 13 of the housing portion 11, enabling electromagnetic coupling with the internal antenna 41. The four sides C2 to C5 are disposed near the opening edges of the housing portion 11 and surround the battery 3. When the opening is closed by the cover 2, the four sides C2 to C5 can be electromagnetically coupled with the external antenna 21.

As described above, since the antenna structure according to this embodiment provides the relay antenna 51 with a three-dimensional structure that fits in the internal space of the housing portion 11, the relay antenna 51 can be easily positioned in the housing portion 11, and displacement thereof is prevented; therefore, operation efficiency can be improved and antenna performance can be maintained.

Since the loop part C1 of the relay antenna 51 is electromagnetically coupled with the internal antenna 41, and the four sides C2 to C5 are electrically coupled with the external antenna 21, a sufficiently large electromagnetic-coupling area can be acquired, and the intensity of the electromagnetic coupling can be sufficiently increased, achieving satisfactory communication.

This embodiment can be appropriately combined with other embodiments.

As described above, according to the present invention, the internal antenna 41 of the SIM card 4, the relay antennas 14 and 51, and the external antenna 21 of the cover 2 can be separated and coupled electromagnetically; as a result, a portable communication terminal in which antenna wirings do not break due to attachment and removal of the cover 2 can be provided.

The present invention is not limited to the embodiments described above, and various modifications are possible so long as the advantages of the present invention are achieved. For example, antennas prepared by sheet-metal processing may be used as the relay antenna and the external antenna. In such a case, antennas having shapes appropriate for communication can be easily prepared. The antenna of the SIM card and relay antenna or the relay antenna and external antenna can be connected in a separatable manner. In such a case, energy loss can be suppressed.

The sizes and shapes illustrated in the accompanying drawings can be appropriately modified so long as the advantages of the present invention are achieved. For example, the size and pattern of an antenna can be changed in accordance with the frequency band and the transmitting power to be used.

In addition, the embodiments can be appropriately modified within the scope of the present invention.

According to the present invention, antenna wirings do not break due to opening and closing the cover. Thus, the antenna structure can be effectively used in, for example, a portable communication terminal, such as a mobile phone.

What is claimed is:

1. An antenna structure comprising:
an external antenna disposed on a cover detachable from an opening of a housing portion of a casing;
an internal antenna disposed on a storage unit and configured to transmit internal information and receive external information and disposed in the housing portion; and
a relay antenna having a first coupling part electromagnetically coupled with the external antenna and a second coupling part electromagnetically coupled with the internal antenna when the cover is attached to the opening of the casing.

2. The antenna structure according to claim 1, wherein an electromagnetic shield configured to reduce electromagnetic field generated between the external antenna and the internal antenna is disposed in the housing portion.

3. The antenna structure according to claim 1, wherein a battery is disposed in the housing portion and part of the relay antenna is disposed along the battery.

4. The antenna structure according to claim 1, wherein the relay antenna forms a loop over an area where the internal antenna is disposed.

5. The antenna structure according to claim 1, wherein the relay antenna is a conductive wire that is three-dimensionally folded to fit into the housing portion of the casing.

6. A portable communication terminal comprising:
a casing having a housing portion with an opening;
a cover detachable from the opening of the housing portion;
an external antenna disposed on the cover;
a storage unit disposed in the housing portion of the casing;
an internal antenna disposed on the storage unit and configured to transmit internal information and receive external information; and
a relay antenna having a first coupling part electromagnetically coupled with the external antenna and a second coupling part electromagnetically coupled with the internal antenna when the cover is attached to the opening of the casing.
